(19) United States
(12) Patent Application Publication
(10) Pub. No.: US 2008/0308442 A1
(43) Pub. Date: Dec. 18, 2008

(54) WATER BOTTLE WITH MEANS FOR PERSONALIZING

(76) Inventors: Alan Spigelman, West Bloomfield, MI (US); Ronald J. Goldstone, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 11/762,499

(22) Filed: Jun. 13, 2007

(51) Int. Cl. B65D 85/00; B65B 7/28; G09F 3/00

(52) U.S. Cl. 206/459.1; 206/459.5; 215/44; 40/310

(57) ABSTRACT

A disposable drink container that includes a bottle that is formed of a plastic material. The bottle has an externally threaded spout and a sidewall. A cap that is threadably engaged to the threaded spout to thereby close the threaded spout. An array of raised projections is formed on an exterior surface of the sidewall. The raised projections are arranged in at least four columns and at least four rows. Each of the projections is deformable. A method for personally identifying a disposable drink container is also provided.

The present invention generally relates to beverage containers and more particularly to a beverage container that may be personalized to uniquely associate the beverage container with a particular person. A method for marking a beverage container is also provided.

Bottled beverages, particularly bottled water and sports drinks, are frequently consumed in public places, such as health clubs and athletic fields, where the beverage containers of several different people may be placed in close proximity to one another. In such situations, it is not uncommon for the owner of one beverage container to mis-identify their beverage container and to consume from the beverage container of another person.

It may be possible to virtually eliminate the mis-identification of one's beverage container if the beverage container were to be personalized by the owner to uniquely identify the beverage container. While we have considered tools, including pens and other marking devices, we are of the opinion, however, that it would not be practical to require a person to carry or seek out a tool for marking a beverage container. Accordingly, there remains a need in the art for a beverage container that may be personalized in an easy and convenient manner.

### SUMMARY

In one form, the present teachings provide a method for personally identifying a disposable drink container. The method includes: providing a plastic bottle having an externally threaded spout and a sidewall, the sidewall including an array of at least sixteen raised projections; and pressing on a plurality of the raised projections (e.g., with a tip of a human finger) to substantially permanently deform the plurality of raised projections in a pattern that corresponds to at least one alphanumeric character.

In another form, the present teachings provide disposable drink container comprising a bottle that is formed of a plastic material, the bottle having an externally threaded spout and a sidewall and a cap that is threadably engaged to the threaded spout to thereby close the threaded spout, wherein an array of raised projections are formed on an exterior surface of the sidewall, the raised projections being arranged in at least four columns and at least four rows, each of the projections being adapted to be deformed when pressed upon.

In yet another form, the present teachings provide a method for personally identifying a disposable drink container. The method includes: providing a plastic bottle having an externally threaded spout and a sidewall, the sidewall including an array with a set of raised projections, the array of raised projections being aligned in at least four columns and at least four rows; and substantially permanently deforming a portion of the raised projections in a pattern that corresponds to at least one alphanumeric character.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an exploded side elevation view of a beverage container constructed in accordance with the teachings of the present disclosure;

FIG. 2 is an elevation view of a portion of the beverage container of FIG. 1 illustrating the first array of raised projections in an “unrolled” condition;

FIG. 3 is a section view of a portion of the beverage container of FIG. 1 taken along the line 3-3 of FIG. 2;

FIG. 4 is an elevation view of another portion of the beverage container of FIG. 1 illustrating the second array of raised projections in an “unrolled” condition;

FIGS. 5 and 6 are views similar to those of FIGS. 2 and 4, respectively, but illustrating the arrays of raised with substantially permanently deformed projections; and

FIG. 7 is a section view of a portion of the beverage container of FIG. 1 taken along the line 7-7 of FIG. 5.

### DETAILED DESCRIPTION OF THE VARIOUS EMBODIMENTS

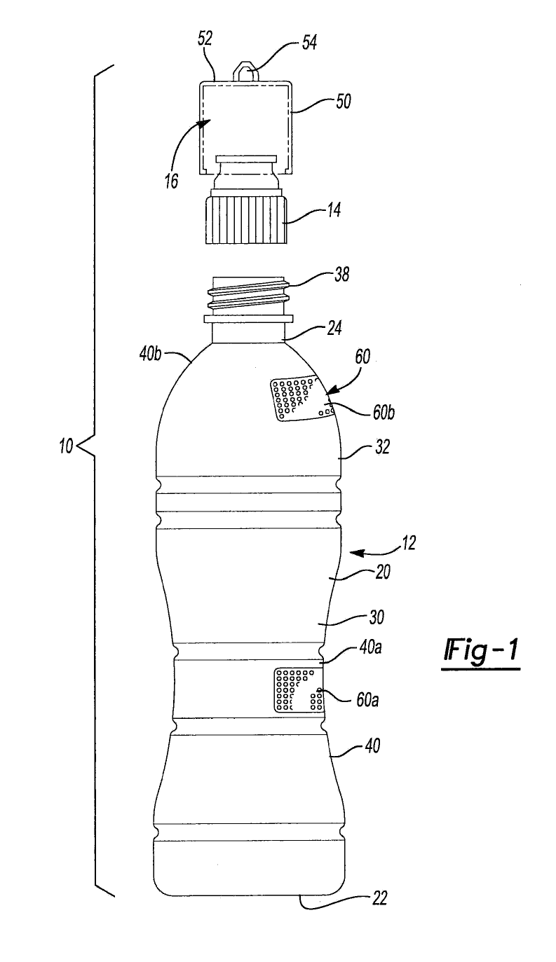

With reference to FIG. 1 of the drawings, a beverage container constructed in accordance with the teachings of the present invention is generally indicated by reference numeral 10. The beverage container 10 can include a bottle 12, a conventional cap 14 and a lid 16. The bottle 12 can be formed of an appropriate plastic material in an appropriate process, such as blow molding, and can include a generally circumferentially extending sidewall 20, a bottom wall 22 and a spout 24. The sidewall 20 can define a body 30 and a shoulder 32 that interconnects the body 30 to the spout 24. The bottom wall 22 can close an end of the sidewall 20 opposite the spout 24. The spout 24 can include one or more helical threads 38 that can be threadably engaged by the cap 14. The bottle 12 can define one or more recessed areas 40; the recessed areas 40 are characterized in that when several of the bottles 12 are disposed adjacent to one another (i.e., as packaged in rows and columns for shipping to a retailer), the recessed areas 40 are not contacted by the adjacent bottles 12. For example, a first recessed area 40a can be defined on a generally convex portion of the shoulder 32, while a second recessed area 40b can be defined by a generally concave portion of the body 30. The lid 16 can be a protective cover that is removably snap-fit to the cap 14. The lid 16 can include an annular wall member 50, a top member 52 that is coupled to the annular wall member 50 and a protrusion 54 that extends from the top member 52.

One or more arrays of raised projections 60 can be formed on the sidewall 20 of the bottle 12 at any desired location, such as on a recessed area 40. In the particular example provided, a first array of raised projections 60a is positioned on the first recessed area 40a on the shoulder 32, and a second array of raised projections 60b is positioned on the second recessed area 40b on the body 30.

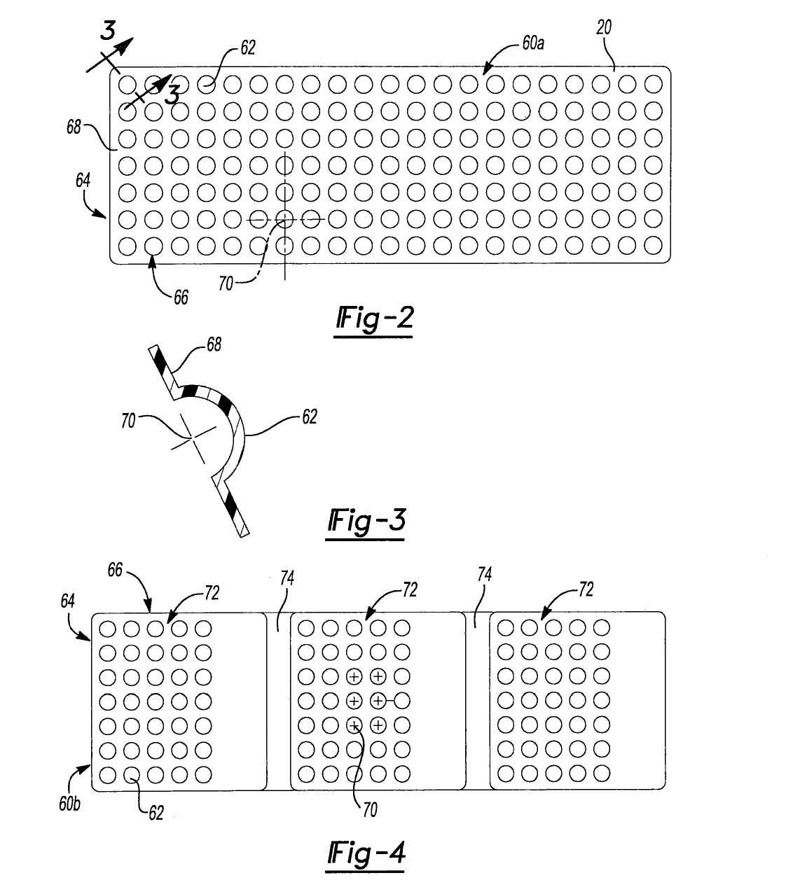

With reference to FIGS. 2 and 3, the first array of raised projections 60a includes a plurality of raised projections 62 that are arranged in rows 64 and columns 66 on an external surface 68 of the sidewall 20. While the rows 64 and columns 66 are illustrated as being generally perpendicular to one another, it will be appreciated from this disclosure that the rows 64 and columns 66 need only be transverse to one another. For example, the columns 66 can be disposed generally vertically along the sidewall 20 while the rows 64 can wrap helically around all or a portion of the sidewall 20 at a predetermined angle, such as 20 degrees.

In the particular example provided, all of the raised projections 62 are integrally formed with the sidewall 20 during the formation of the bottle 12 and are shaped as a spherical cap with a base diameter of about 0.1 inch, but it will be appreciated that the raised projections 62 could be formed to any desired size, geometric shape or combination of sizes and/or shapes. It will be appreciated that the geometric shape of a given one of the raised projections includes its exterior surface and as such, ornamentation of the exterior surface is expressly contemplated herein. For example, the exterior surface of one or more of the projections 62 could include surface ornamentation that gives the projection the appearance of a face. The first array of raised projections 60a includes at least four rows 64 and four columns 66, such as at least four rows 64 and five columns 66, with each of the rows 64 and columns 66 intersecting at a convergence point 70. In the particular example illustrated, the first array of raised projections 60a includes seven rows 64 and twenty-one columns 66. The raised projections 62 can be disposed in at least 70% of the convergence points 70, but in the example illustrated, the raised projections 62 are disposed in substantially all (i.e., greater than 95%) of the convergence points 70.

With additional reference to FIG. 4, the second array of raised projections 60b can be generally similar to the first array of raised projections 60a except that the second array of raised projections 60b can be segregated into a plurality of sub-arrays 72 that can be spaced apart from one another by a space 74 that is greater than a spacing between adjacent columns 66 within one of the sub-arrays 72. Each of the sub-arrays 72 can include at least four rows 64 and four columns 66 and the raised projections 62 can be disposed in at least 90% of the convergence points 70.

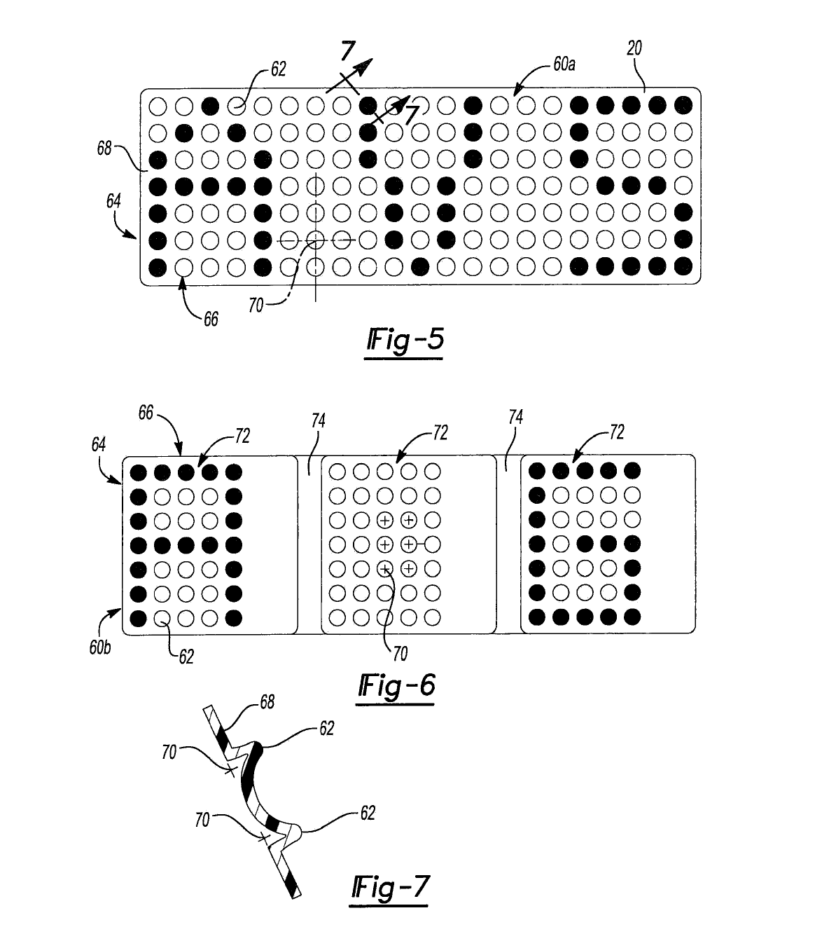

With reference to FIGS. 1 and 5 through 7, the bottle 12 may be personalized or uniquely identified by the owner by substantially permanently deforming (e.g., depressing) the raised projections 62 in a desired pattern. For example, the desired pattern may consist of at least one alphanumeric character, such as one or more of the initials of the owner, a word, a phrase or a sentence. The raised projections 62 may be deformed by pressing on individual ones or groups of the raised projections 62 with the finger of the owner or with the lid 16 (e.g., with the protrusion 54 that extends from the top member 52). The size of the raised projections 62 as well as the number of rows 64 and columns 66 can be selected to provide a desired “resolution”, as well as to provide a desired capacity. In this regard, the number of columns 66 could be selected so that the array of raised projections extends around a desired portion of the sidewall 20, such as one quarter, one half or substantially completely about the sidewall 20. It will be appreciated that where the array of raised projections 60 is sufficiently long, it will be possible to personalize the beverage container 10 with one or more words.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

What is claimed is:

1. A method for personally identifying a disposable drink container, the method comprising:
providing a plastic bottle having an externally threaded spout and a sidewall, the sidewall including an array of at least sixteen raised projections; and
pressing on a plurality of the raised projections to substantially permanently deform the plurality of raised projections in a pattern that corresponds to at least one alphanumeric character.

2. The method of claim 1, wherein the array includes at least four columns and at least four rows.

3. The method of claim 2, wherein the array is segregated into a plurality of sub-arrays, each sub-array being spaced apart from an adjacent sub-array by a space having a width that is greater than a spacing of adjacent columns within one of the sub-arrays.

4. The method of claim 1, wherein the array extends about at least one quarter of a perimeter of the sidewall.

5. The method of claim 4, wherein the array extends about at least one half of the perimeter of the sidewall.

6. The method of claim 5, wherein the array extends substantially completely about the perimeter of the sidewall.

7. The method of claim 1, wherein the at least one alphanumeric character form at least one of a name and a word.

8. A disposable drink container comprising a bottle that is formed of a plastic material, the bottle having an externally threaded spout and a sidewall and a cap that is threadably engaged to the threaded spout to thereby close the threaded spout, wherein an array of raised projections are formed on an exterior surface of the sidewall, the raised projections being arranged in at least four columns and at least four rows, each of the projections being adapted to be deformed when pressed upon.

9. The disposable drink container of claim 8, wherein the sidewall defines a body and a shoulder, the shoulder interconnecting the body and the spout and wherein the array of projections is formed on the shoulder.

10. The disposable drink container of claim 8, wherein the sidewall defines a body and a shoulder, the shoulder interconnecting the body and the spout and wherein the array of projections is formed on a recessed zone defined by the body.

11. The disposable drink container of claim 10, wherein the recessed zone is a concave-shaped portion of the body.

12. The disposable drink container of claim 8, wherein the rows and the columns are generally perpendicular to one another.

13. The disposable drink container of claim 8, wherein the rows and the columns intersect at convergence points and wherein the raised projections are disposed in at least 70% of the convergence points.

14. The disposable drink container of claim 13, wherein the raised projections are disposed substantially all of the convergence points.

15. The disposable drink container of claim 8, wherein the array includes seven or more rows.

16. A method for personally identifying a disposable drink container, the method comprising:
providing a plastic bottle having an externally threaded spout and a sidewall, the sidewall including an array with a set of raised projections, the array of raised projections being aligned in at least four columns and at least four rows; and
substantially permanently deforming a portion of the raised projections in a pattern that corresponds to at least one alphanumeric character.

17. The method of claim 16, wherein the array is segregated into a plurality of sub-arrays, each sub-array being spaced apart from an adjacent sub-array by a space having a width that is greater than a spacing of adjacent columns within one of the sub-arrays.

18. The method of claim 16, wherein the array extends about at least one quarter of a perimeter of the sidewall.

19. The method of claim 18, wherein the array extends about at least one half of the perimeter of the sidewall.

20. The method of claim 16, wherein the sidewall defines a body and a shoulder, the shoulder interconnecting the body and the spout and wherein the array of projections is formed on a recessed zone defined by the body.

21. The method of claim 16, wherein the sidewall defines a body and a shoulder, the shoulder interconnecting the body and the spout and wherein the array of projections is formed on a recessed zone defined by the body.

22. The method of claim 21, wherein the recessed zone is a concave-shaped portion of the body.

23. The method of claim 16, wherein the at least one alphanumeric character form at least one of a name and a word.
